(19) United States
(12) Patent Application Publication
(10) Pub. No.: US 2011/0159457 A1
(43) Pub. Date: Jun. 30, 2011

(54) BLOOD ABSORBING DEVICE

(75) Inventor: Thomas Offermann, La Turbie (FR)

(73) Assignee: T.A. DENTAL INNOVATIONS S.A.R.L., Monaco (MC)

(21) Appl. No.: 12/999,204

(22) PCT Filed: Jun. 16, 2009
(86) PCT No.: PCT/EP09/04334

§ 371 Date: Feb. 23, 2011

(30) Foreign Application Priority Data
Jun. 16, 2008 (DE) 10 2008 028 525.0
Jan. 19, 2009 (DE) 10 2009 005 058.2
Mar. 23, 2009 (DE) 10 2009 014 503.6

(51) Int. Cl. A61C 19/06; A61C 17/06

(52) U.S. Cl. 433/91; 433/136

(57) ABSTRACT

The present invention proposes an apparatus (1) for collecting blood or a different fluid escaping from a wound area, the apparatus (1) comprising a contact device (17) for contacting blood or fluid within the wound area, wherein the contact device (17) comprises a multitude of pores (19) for absorbing the blood or fluid contacted by means of the contact device (17) within an interior of the contact device (17).

The present invention relates to an apparatus according to claim 1 for collecting or extracting blood escaping or exiting from a wound area. It further relates to a clamping device or pushing device according to claim 31, a depository device according to claim 32 as well as a set according to claim 40.

In dentistry, the use of bone regeneration or replacement, respectively, material as a prosthetic bone material is prevalent. These implantation materials include, e.g., calcified microporous copolymer materials, which are commercially available under the names Bioplant®, HRT®, Synthetic Bone-Alloplast, tricalcium phosphate “Aerosorb” by the company Corasan, “Bio-Oss” by the company Geistlich, and the like.

The above mentioned and further bone regeneration or replacement, respectively, materials are prepared for their use by adding the patient's own blood. The blood used herefor is sucked from the bleeding wound base of the operation site as bone marrow-containing blood and subsequently added to the granular bone regeneration material. The viscous fluid mixture generated herewith can then be delivered manually to the site of action.

Though, apparatuses for delivering the viscous fluid mixture of blood and bone replacement material at the site of action are known from state of the art (see, for example, U.S. Pat. No. 4,366,822); however, so far, no specially prepared apparatus for absorbing the blood from the wound base of the operation site prior to its admixture to the bone replacement material is available a dentist.

One object of the present invention is therefore to propose an apparatus for collecting blood or other fluids escaping from a wound area, in particular for their further use.

The object of the present invention is solved by the feature combination of claim 1

Thus, an apparatus for collecting blood or other fluids escaping from a wound area is proposed, the apparatus comprising a contact device for contacting the bleeding wound area, the contact device comprising a multitude of—in particular blood permeable or blood-admitting—openings or pores (in the following shortly referred to as: pores). The pores serve for absorbing the contacted blood into an interior of the contact device. The interior may comprise or consist of sections of the pores or openings.

The pores may be designed or embodied such that they indeed permit a permeation or penetration of fluid, in particular blood, however, inhibit a permeation or penetration of solid materials such as bone fragments and the like being present in the contacted blood. As a multitude of—e.g., blood permeable—pores are provided, solids or solid objects present in the contacted blood may clog at most some of the pores and thus disable them. With intended use of the apparatus according to the invention, however, a sufficient number of pores that will not clog and therefore serve for the absorption of blood further on will remain in the wound area, e.g., within the patient's oral cavity.

The pores thereby may be embodied such that they evolve a capillary attraction or effect, whereby a suction device or the like is not mandatorily necessary. In addition, an apparatus according to the invention based on capillary attraction may advantageously be operated with, e.g., only one hand. Also, cleaning the suction device and/or discarding disposable articles necessary for operating the suction device, such as tubes and the like, are omitted.

The capillary attraction may additionally be improved by known methods for increasing the surface tension or the wetting capability, respectively, of the material of the apparatus used. An example for such a method is the corona treatment, an electrochemical method for the surface modification of plastic or synthetic materials. The method of plasma-enhanced chemical vapour deposition (PECVD) may also be used herefor.

Preferably, a synthetic material having appropriate biocompatible properties is used as material for the contact device. Such a material may be polyurethane foam. The pores' diameters may be measured such that favourable characteristics are present for absorbing the medium to be absorbed, such as, e.g., blood. The number of cells per inch (ppi) may be set or determined according to the necessary flow properties in or within the material as well as the capillary attraction. For example, a value between 60 and 80 ppi is given. This corresponds to an approximate mean pore diameter between 0.5 and 0.75 mm.

For example, also a polyurethane foam product such as VOCO Pele Tim® by the company VOCO GmbH from Cuxhaven, Germany, e.g., having wedge shape, 6×8 mm, may be used which has already been utilized in the dental field. These foam pellets are advantageously characterized by their hygienic, lint-free application. Additionally, they are sterilizable, if needed.

Advantageous embodiments or developments of the object according to the invention are each subject-matter of the dependent claims.

Thus, in a preferred embodiment, the apparatus according to the invention comprises a suction device for generating a suction acting on the contact device—and via the contact device onto a contacted blood or a different fluid. The advantages associated herewith encompass increasing a suction power or performance and/or absorption capacity of blood present within the wound area. The latter may advantageously shorten the time necessary for collecting the blood. Furthermore, in a case where only small quantities of blood are present, a blood amount sufficient for the respective purpose may be collected more easily.

In yet another preferred embodiment, the apparatus according to the invention comprises a compressing device by means of which pressure may be applied onto the contact device. This way, blood having been absorbed into or within the interior of the contact device may be released more easily from the interior again, for instance by pressing, squeezing, pushing or wringing, e.g., for further use thereof.

Providing a reservoir for a fluid or a blood reservoir at or on the apparatus according to the invention for retaining or storing collected blood after its permeation through the interior of the contact device—and thus through the contact device itself—on the one hand allows for a small design of the interior of the contact device. This further allows for reaching more easily wound areas that are difficult to access or reach by means of the apparatus according to the invention and, by means of the blood reservoir, for storing or retaining blood in a better way and, optionally, using it further on. The blood reservoir may, for instance, be furnished with an anticoagulant coating or substance.

In an again further preferred embodiment of the apparatus according to the invention, the apparatus comprises a connecting device for connecting the apparatus with a customary injection syringe in a fluid communication. According to this embodiment, the apparatus according to the invention may therefore advantageously be connected with material already present in the medical and the dental field, such as injection syringes, in a simple manner. Thereby, the injection syringe may serve for both generating a suction power or performance and for absorbing the blood in the sense of a blood reservoir such as described above comprising the advantages associated therewith.

In an again further preferred embodiment, the apparatus according to the invention comprises a compressing device by means of which pressure is applied by means of a simple pushable or pushing device by a piston. This advantageous embodiment allows for an easy operating of the apparatus with one hand and enables the user to execute other tasks in parallel. Thus, e.g., the wound area from which blood shall be taken by means of the apparatus may be exposed in a better and easier way.

This embodiment further offers the possibility of collecting blood several times from the contact device by applying pressure with a single-handed operation. With this pressure application by the pushable or pushing device, the blood may either flow into an attached reservoir due to gravity, or, with a positioning turned by 180 degrees, be collected in a different container or repository.

In the embodiment comprising the retention or storage in an attached reservoir, there is further proposed an opening in the housing of the reservoir for withdrawing or extracting or draining the blood easily. This offers the advantage that the blood may be further used quickly and easily without having to be conducted through the contact device again. Further an appropriate device for closing this opening is further proposed which may, e.g., be realized by means of a plastic snap connection corresponding to the state of the art.

In an again further preferred embodiment, the apparatus according to the invention comprises a rotary device, the rotary motion of which is transmitted through a thumb or finger by means of a device to or onto a guiding device at or to or onto which the contact device is fixed or attached.

The rotary device may (in the present text, the term “may” is to be understood in the sense of “preferably”) comprise at least one wheel-shaped structure.

The rotary device may convert a rotary motion into a translational motion or a linear motion, in particular a displacement motion.

In a further preferred embodiment, the apparatus according to the invention may comprise a reservoir for a bone regeneration substance. Thus, blood collected by means of the contact device may be prepared for its use within the apparatus.

The present invention may also be used for intaking blood, other fluids or tissue and bone fragments by means of the contact device in order to subsequently discard them. This way, fluids, mostly blood or wound secretions, or impurities or contaminations may be removed during operations by means of the contact device according to the present invention.

The present invention is not limited to its use in dentistry, but can be used in the whole surgical field—e.g., in abdominal surgery. There, substantially larger amounts of blood than in dentistry are common, so that some of the embodiments described above which, e.g., comprise a continuous suction device, offer particular advantages here. Further possible fields of applications are, for instance, orthopaedics or bone surgery, in which the present invention may advantageously be used for, e.g., for the absorption of wound blood from the cancellous bone or spongiosa.

For the above-mentioned and other applications, all embodiments may have a substantially larger scale or measure and may be suited for absorbing a larger amount of blood than is common and necessary in the dental field.

The apparatus according to the invention may further also serve for extracting or taking samples of blood or other fluids. A sample may, e.g., be taken during an operation for a subsequent analysis. Its result may be used for influencing the further course of the operation. Herefor, especially one of the closable embodiments according to the invention is suited.

In an again further preferred embodiment, the apparatus according to the invention comprises a device having a sliding or shifting or pushing mechanism. By means of the pushable or pushing device, the contact device may be transferred into a position, in which structures of the apparatus apply pressure on or onto the contact device such that at least a part of the blood/the fluid retained or stored herein may be discharged from of the contact device.

In an again further preferred embodiment, the apparatus according to the invention comprises a housing having an opening which is embodied, e.g., longitudinally. Through the opening, the piston that is later on arranged slidably or shiftably in or within the housing, and comprising an accommodation device for the contact device and a section for initiating a displacement or shifting or sliding motion or a pushing or pushable device, respectively, may be inserted in or mounted with, respectively, the housing.

For this purpose, the apparatus according to the invention may be designed or embodied substantially in two pieces (housing and piston), not considering the contact device for once in this case. This two-piece embodiment offers the advantage that the parts may each be easily produced, e.g., by using an injection-moulding process. Furthermore, the assembly can be easily accomplished due to the small amount of parts. The assembly of both parts may moreover preferably be carried out by hand or manually, i.e., without using any tools. This provides for the advantage that the parts may be produced, sterilized and packed separately and be assembled at the end user's site. This allows for treating the several or different parts differently (e.g., sterilizing them or designing them germ-reduced or germ-free in different ways). It is known to the person skilled in the art, that during a sterilization process of synthetic materials or plastics, for instance, polyethylene, which is often used in medical products, deformations of material may occur. Such deformations may lead to fitting problems between piston and housing and disadvantageously complicate or even inhibit any displacement or shifting or sliding motion. Thus, with parts having already been assembled before sterilization, it may come to—using as an example the present invention—that a displacing or moving or shifting of the piston within the housing is no longer guaranteed. Through the possibility of the two-piece embodiment, however, it is advantageously possible to prepare the parts of the apparatus according to the invention separately and thereby, e.g., already sterilize them and have them assembled by the user, e.g., only when required. As only two parts are involved, this is possible on-site in a quick and easy manner, without any special effort, preferably also without any tools.

In an again further preferred embodiment, the two parts (piston and housing) of the previous embodiment may comprise appropriate limiting devices such that their disassembly is aggravated or preferably inhibited without being destructed once having been put together or assembled.

Suitable limiting devices may, for example, be designed or embodied by—in particular elastic—plastic barbed hooks that allow for an assembly of the two parts, while, however, inhibiting or notably aggravating their disassembly by the user. The construction principles of such plastic barbed hooks, e.g., in the form of snap lock or catch, are known to the skilled person.

The limiting devices may, for instance, during mounting, the piston into the housing, lock or snap or snap in, or during displacing or moving or shifting the piston in or within the housing for the first time after mounting, depending on the constructional embodiment.

When or if the snapping function is actuated after displacing or moving or shifting the piston for the first time, after the mounting a confining of the displacement path of the piston may be effected thereby and a renewed positioning of the piston into the starting position and the disassembly may be inhibited or aggravated, respectively.

Providing limiting devices in the proposed embodiment may advantageously prevent the user from disassembling the parts after having used the apparatus, possibly cleaning the parts and processing or preparing them for further use. This way, the known risks in connection with the handling of blood known to the skilled person are prevented.

In an again further preferred embodiment, the housing may be produced from a transparent plastic or synthetic material in order to enable an, e.g., optical control of the retraction of the piston.

In a further preferred embodiment, the apparatus according to the invention has the shape of tweezers or is in at least one section designed or embodied having the shape of tweezers. It comprises at least two arms having at least one jaw each for gripping, in particular clamping, the contact device, as well as at least one clamping or pushing or pushable, respectively, device by means of which an action or effect may be exerted on sections of the apparatus for fixing the arms in a position relative to each other.

The present invention furthermore proposes a depository device for depositing or accommodating the apparatus according to the invention. This device serves for storing the contact device in moments in which it is not required during the treatment of the patient, whereby it should be further usable nevertheless. Therefor, the depository device may encompass a socket or a pedestal comprising at least one opening provided or intended and arranged for supporting the apparatus according to the invention in the interior of the opening. Alternatively, the depository device comprises at least one bolt or spike or pin on or onto which the apparatus may be put or slipped.

Hereby, in a preferred embodiment, preferably a clamping effect may be exerted onto the contact device by means of sidewalls or other sections in order to further securing the contact device against an unintended falling out of the depository device.

Furthermore, the depository device may be designed or embodied in its geometry for accommodating the contact device. Both elements therefore may have been provided to match each other upon producing them.

The contact device may in a further preferred embodiment be secured in the depository device by geometrical, physical embodiments of the depository device alone. Herefor, indentations, stops, ledges, protrusions and the like may be provided.

The depository device according to the invention may, instead of a socket or pedestal, comprise fixing or attaching devices for a detachable connection, which may ensure a spacing of the apparatus deposited in the depository device or the contact device, respectively, from a possibly unclean or unsterile depository area. Those fixing or attaching devices may, among others, include clamping devices, bolts or spikes or pins already mentioned above etc.

The depository device according to the invention may be designed or embodied for being secured against unintendedly overturning or toppling over. This includes reducing the risk of overturning or toppling over yet.

In the following, the present invention is exemplarily illustrated by means of the appended drawing, in which same reference numerals denote same or identical or similar components. In the partly greatly simplified figures, it applies:

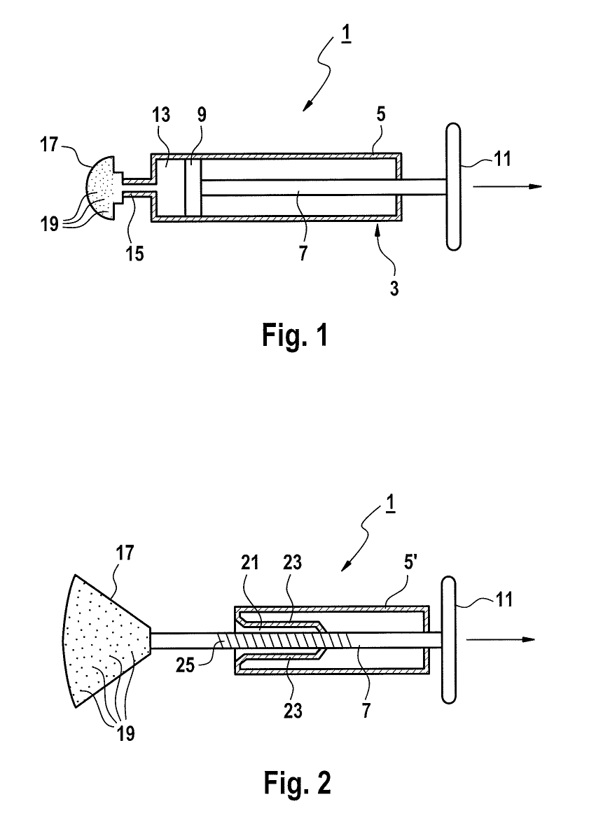

FIG. 1 shows an apparatus according to the invention in a first embodiment in a partial section;

FIG. 2 shows an apparatus according to the invention in a second embodiment in a partial section;

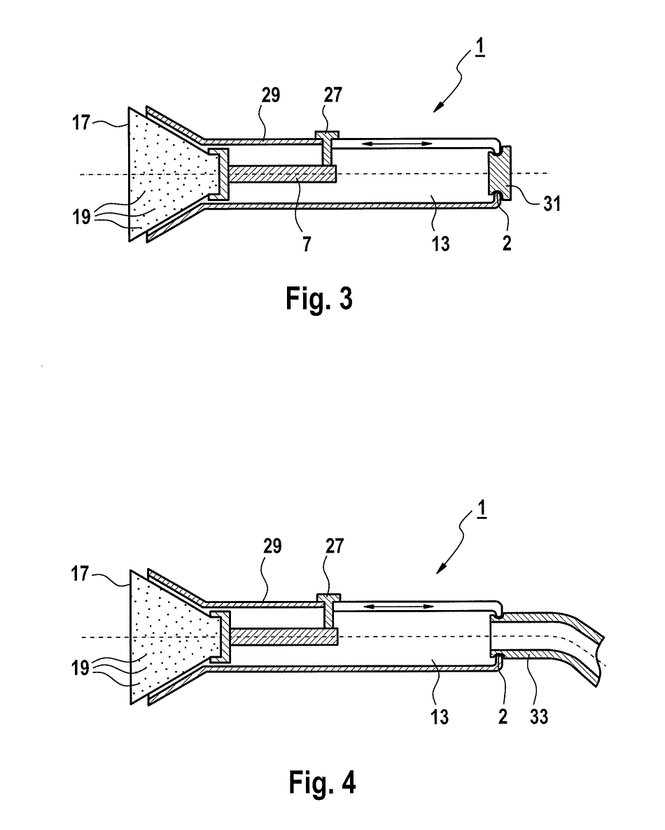

FIG. 3 shows an apparatus according to the invention in a third embodiment in a partial section;

FIG. 4 shows an apparatus according to the invention in a fourth embodiment in a partial section;

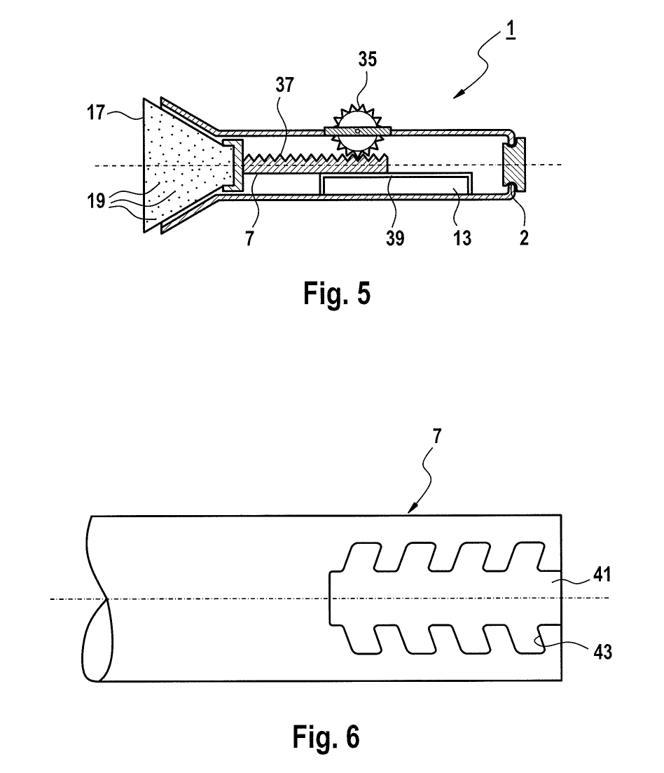

FIG. 5 shows an apparatus according to the invention in a fifth embodiment in a partial section;

FIG. 6 shows in a partial representation a piston of an apparatus according to the invention for fixing or attaching a contact device hereto;

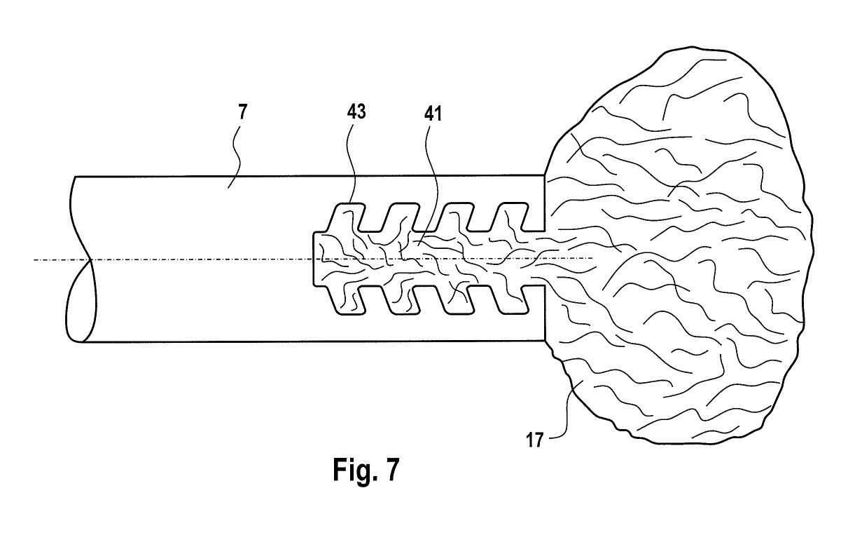

FIG. 7 shows the piston of FIG. 6 in a partial representation with a contact device being fixed or attached thereto;

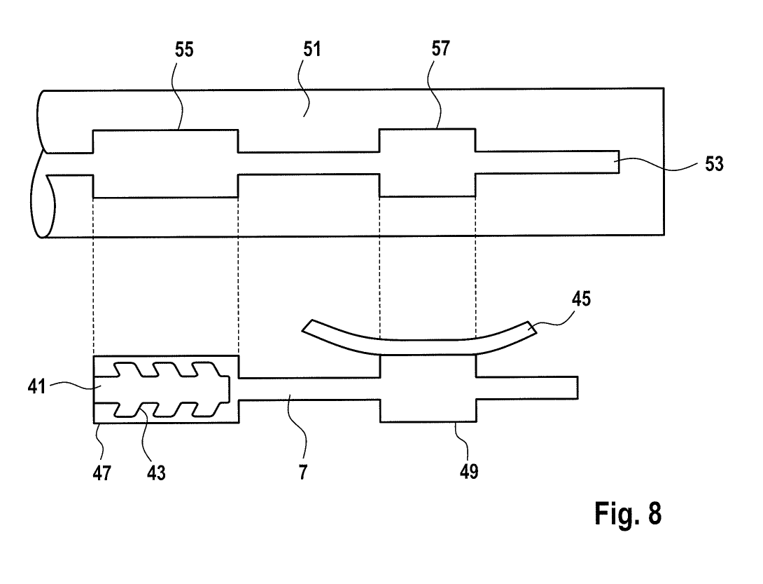

FIG. 8 shows a piston in a sixth embodiment and sections of a corresponding housing;

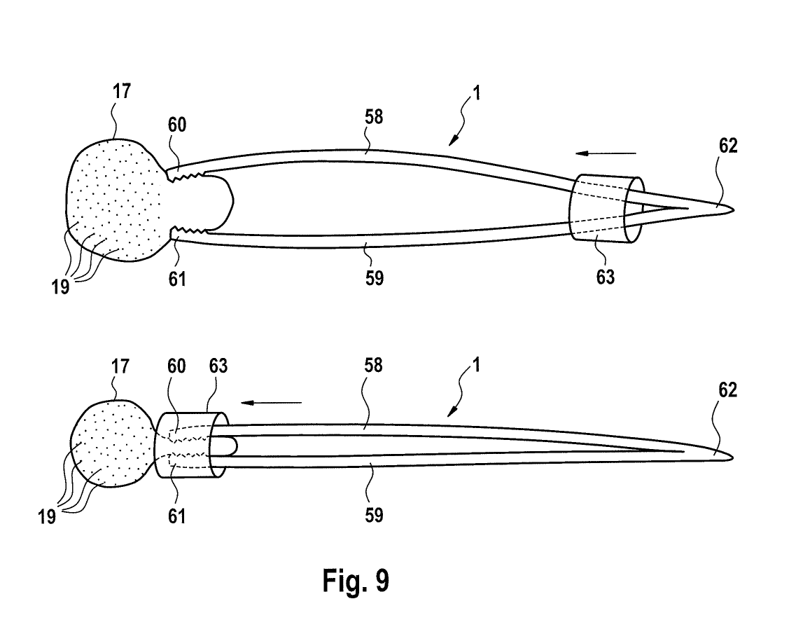

FIG. 9 shows an apparatus according to the invention in a sixth embodiment in a lateral or side view;

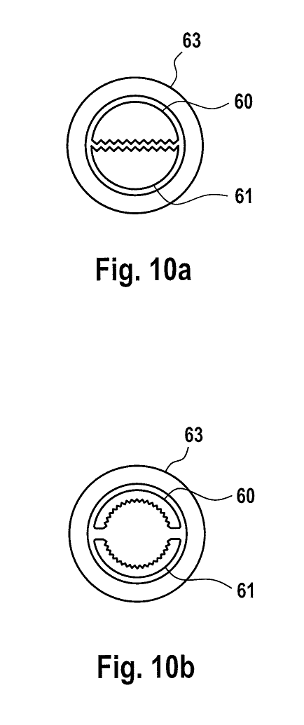

FIG. 10a shows the sixth embodiment of FIG. 9 in a front view;

FIG. 10b shows a seventh embodiment of FIG. 9 in a front view;

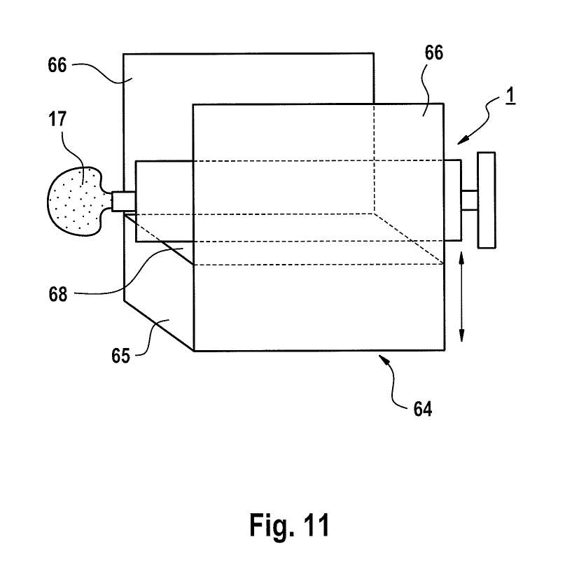

FIG. 11 shows a first embodiment of a depository device for an apparatus according to the invention in a perspective view; and

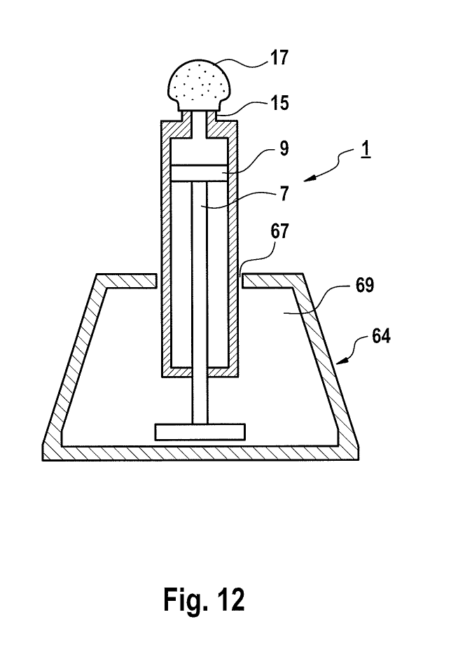

FIG. 12 shows a second embodiment of the depository device for an apparatus according to the invention.

FIG. 1 shows in a schematically simplified manner an exemplary embodiment of the present invention in a first embodiment. The apparatus 1 comprises a conventional injection cannula 3 having a housing 5, a piston 7 that is arranged shiftably or moveably within the housing 5, the piston 7 having a sealing portion 9, and a handle 11. By pulling the handle 11 in the direction indicated by means of the arrow, a negative pressure or vacuum is generated in the area 13 of the injection cannula 3, the vacuum being communicated to a contact device 17 of the apparatus 1 according to the invention by means of a fluid communication via a connection device 15.

The contact device 17 comprises a multitude of pores 19 through which blood may enter into an interior of the contact device 17 that is not further specified or illustrated in FIG. 1. The contact device 17 is in the first embodiment of FIG. 1—similar to the head of a watering can for dispersing water by means of a plurality of thin single streams—produced from a material having a consistency or strength stability such that the contact device 17 does not collapse when being subjected to a negative pressure by means of the suction device 9, 11.

Should individual pores 19 of the contact device 17 be clogged by, e.g., sucking in bone fragments during use of the apparatus 1 according to the invention when absorbing blood, the blood may still be absorbed through the contact device 17 into the section 13 serving as blood reservoir, in which negative pressure is present. The apparatus 1 according to the invention may thus also be used for collecting blood from a contaminated—or generally comprising solids or solid objects—wound base.

In the section 13 of the FIG. 1, a bone regeneration material may be held.

FIG. 2 shows the apparatus 1 according to the invention in a second embodiment, in which the apparatus 1 does not comprise a conventional injection syringe but a piston 7 having a handle 11, the piston 7 being accommodated in a housing 5′ and being connected to a contact device 17 made of sponge-like material having pores 19. Thereby, the housing 5′ comprises a—preferably tapering—sunk area 21 into which, by pulling the handle 11 in the direction indicated by the arrow, the sponge-like contact device 17—after having absorbed blood—may be pulled. This may take place, e.g., after completion or termination of the process of collecting blood from the wound area and has the effect of wringing out the sponge-like contact device 17 in the section 21. The side walls 23 of the section 21 thereby exert pressure onto the compressible material of the contact device 17. Thereby, blood absorbed into an interior of the contact device 17 is pushed out of the contact device 17 for its further use.

It is obvious that the section 21 as well as its side walls 23 may comprise each suitable form or shape for optimized squeezing blood out of the sponge-like contact device 17. Thus, they may be designed or embodied funnel-shaped, tapered, triangular and the like. Also wavy or undulating profiles as well as sharp edges may be provided. As indicated in FIG. 2, the apparatus 1 may, e.g., in the area of its piston, comprise a worm or thread 25 by means of which a rotary motion on or onto the piston 7 may be effected when pulling the handle 11. This rotary motion may be decoupled from the handle 11 by means of suitable constructional measures known to the skilled person such that the user of the apparatus 1 does not have to feel or notice a rotary motion of the piston or of certain sections thereof, respectively, when pulling the handle 11.

It is pointed out that, e.g., the reservoir effect of the section 13 of FIG. 1 is combinable with the apparatus 1 of FIG. 2. Furthermore, also the rotary motion as well as the devices required therefor of the second embodiment in FIG. 2 are or will be combined with a device for generating suction as may be taken from FIG. 1 or with other features of the apparatus 1 of the first embodiment of FIG. 1.

The sponge-like design of the contact device 17 of the second embodiment of FIG. 2 may thereby be such that the contact device 17 may withstand any suction. In this case, it acts at the same time by generating suction and by a capillary effect that is inherent to the sponge-like material. Vice versa, the first embodiment of FIG. 1 may, besides its suitability for applying negative pressure in order to collect blood, also show an inherent capillary effect for supporting the pull or suction effect.

The housing may, in particular in the second embodiment of FIG. 2, be embodied from metal and may be sterilizable. The housing 5 or 5′ may thereby, however, also be provided to be made of a disposable material. The contact device 17 may be designed to be exchangeable. This applies both for the first and the second embodiment.

FIG. 3 shows the apparatus 1 according to the invention in a third embodiment, in which the contact device 17 is fixed or attached to or at a piston 7 which may be moved or shifted into the housing 29 and, if needed, also out of the housing 29 by means of a pushable or pushing device 27. Similarly as shown in FIG. 2, by means of this pushing or shoving motion, the sponge-like material of the contact device 17 is compressed and blood present therein is squeezed out. Depending on the location or position in which the apparatus 1 is held or maintained, the blood, due to gravity, flows into the reservoir 13, or, if the apparatus 1 is held or kept the other way round, out of the contact device 17 into an arbitrary container or repository not shown here, below or underneath the apparatus 1. This procedure may be repeated several times. The contact device 17 may absorb blood again in the meantime. If the blood flows corresponding to the holding direction of the apparatus 1 into the reservoir 13, the blood present therein may emptied by opening a device 31 for closing. In the reservoir 13, e.g., bone regeneration material may be contained. The device 31 for closing may preferably be closable or lockable in a fluid-tight manner.

Due to the simple and integrated arrangement of the pushable or pushing device 27 in or within the housing 29, it may be possible to perform the whole handling with one hand.

Furthermore, due to the simple constructional design, it is possible to produce the whole apparatus 1, except for the contact device 17, in a cost-effective plastic or resin injection-moulding process. This is of particularly advantage when using the apparatus 1 in connection with blood and bone regeneration material, due to reasons known to the skilled person. Also a subsequent, known sterilization process is easily feasible.

In FIG. 4, instead of the lock 31 as shown in FIG. 3, a tube or tubing 33 is attached to the housing 29. By means of this tubing 33, blood may be continuously taken from the reservoir 13 and be processed or discarded. Thus, the process of intermittently opening and emptying is omitted, which may offer advantages for the practical application of absorbing blood in a wound area—in particular in case of large amounts of blood. Instead of a tubing, any arbitrary other form, e.g., a cannula, a syringe or a container may be attached to the opening 2.

Furthermore, also a suction device not specified and not shown here may be attached to the tubing. The suction resulting therefrom may enhance the capillary effect of the contact device 17 for being filled with blood and/or suck off the blood out of the reservoir 13. Thus, a continuous emptying of the reservoir 13 independent from the location and position of the apparatus 1 is possible.

In FIG. 5, the pushable or pushing device of FIG. 3 and FIG. 4 is substituted by means of a rotary device 35, the rotary motion of which is transferred to or onto a guiding device 37 by means of a device. This guiding device 37 is guided on a carnage or carrier 39. Thereby, a rotatory motion is converted into a translational motion. This translational motion corresponds to the motion of the piston 7 already described above, which serves for moving the sponge-like material of the contact device 17 into a constriction or narrow part so that the sponge-like material is compressed there and blood present therein is squeezed out of it. In certain embodiments, the rotary device 35 may, for instance, be a knurled screw which is moved or turned, respectively, by means of a finger. Here, it is also advantageous that the whole handling may be performed with one hand. In comparison to the pushing device 27 shown in FIG. 3 and FIG. 4, the embodiment by means of a rotary device 35 offers the advantage that the linear motion of the piston 7 may be guided and controlled more exactly.

The pushing device 27 may thereby extend from an interior of the apparatus 1 to an exterior.

The pushing device 27 may preferably be shiftable through an opening of a periphery of the jacket or jacket limiting surface of the apparatus 1.

It may preferably not be shiftable or movable through a front surface of the apparatus.

In FIG. 6, a part of the piston 7 for the apparatus 1 according to the invention is shown, the part of the piston 7 comprising a partial opening 41 having a saw tooth structure 43. The saw tooth structure 43 serves for accommodating the contact device 17, which is being clamped into the partial opening 41 in the sense of an inside retention. For accommodating the contact device 17, the partial opening 41 may, e.g., be pushed or forced apart manually or with the aid of appropriate grippers or clamping tools in order to mechanically fixate, in particular clamp, the contact device 17 within the partial opening 41.

Subsequently, the elastically widened material of the edge or border or rim of the partial opening 41 ideally completely returns into the original position or the initial state. The use of tools is advantageously not required herefor.

The contact device 17 may, however, also initially be brought or put to a smaller or narrower diameter or measure by twisting or skewing or warping the partial opening 41 without widening the borders or rims thereof, and then, in this form or shape, be introduced through the partial opening 41 or an arbitrarily designed slot into an interior of the piston 7, where it then may unfold again into a form or shape having a larger diameter by means of unfolding and thereby jam or clamp in or within the interior of the piston 7. The use of tools is again advantageously not required herefor.

Due to the mechanical clamping, no further fixing aids such as adhesives or additional mechanical connections or linkages such as clips or cramps, respectively, rivets or studs, respectively, hooks and the like are necessary. Thus, a step of adhering or combining or connecting, respectively, by means of tools is advantageously dispensable. Furthermore, components of the adhesive may not enter, e.g., an oral cavity. Additionally, injuries caused by sharp-edged or hard additional mechanical connections or linkages may not occur, as such linkages are not required for the proposed clamping. With the proposed clamping, an endangerment of the patient may therefore advantageously be ruled out.

Apart from the saw tooth profile 43, all other geometries—also having barbed hooks and the like—or appropriate profiles for the purpose of mechanical clamping are also possible. These may also protrude into an interior of the piston 7 and thereby contribute to a further increase or enhancement of the degree of fixation or the fixation effect.

The shown piston 7, in the representation of FIG. 6 comprises a corresponding partial opening 41 only in the area of the saw tooth profile 43. However, the piston 7 may also be designed to be completely or continuously hollow in an inner area thereof. It may be designed for enabling a suction effect through itself, e.g., along its longitudinal axis.

As a material for the piston 7, exemplarily polyurethane or polyester, preferably in medical grade specification, may be used.

In FIG. 7, the piston 7 is represented having a contact device 17 clamped or fixated, respectively, therein.

In its lower or bottom representation, FIG. 8 shows a piston 7 in a further embodiment of the apparatus according to the invention in a lateral or side view. The piston 7 is designed here in a staggered form, i.e., it has different diameters along its longitudinal axis. In its front area (on the left side in FIG. 8), the piston 7 comprises a partial opening 41 for accommodating a contact device, which is not shown here, by means of a saw tooth profile 43.

The piston 7 further comprises a pushing device 45, by means of which the piston 7 may be shifted or moved, e.g., by means of the thumb in or within a housing described later on.

In its front end (at the left border of the representation of FIG. 8), the piston 7 comprises a broader or wider section 47, and in its rear portion, it comprises a broader or wider section 49.

The housing 51 shown partially and in a top view in the upper portion of FIG. 8, comprises a staggered slot 53. The slot 53 extends along a longitudinal direction of the housing 51 and of the apparatus 1 according to the invention.

The slot 53 preferably connects an interior of the apparatus 1 with an exterior.

The slot 53 comprises two widenings or broadenings or enlargings 55 and 57.

As can be seen by means of the dashed lines between the upper and the lower representation of FIG. 8, the widenings or broadenings or enlargings 55 and 57 are provided in embodiments in order to accommodate the broader or wider section 47 and the broader or wider section 49. By displacing or shifting the piston 47 relative to the housing 51, e.g., by use of the pushing device 45, the piston 7 is thus bolted or interlocked and additionally conducted or guided in or within the slot 53 arranged lengthwise in the housing 51.

The enlargings 55 and 57 and the broader or wider sections 47 and 49 are to be understood as a device based on the lock-and-key principle. According to the invention, any other device than the device shown in the drawing may be used, by means of which a lock-and-key principle may be realized. In particular, the invention is not restricted to exactly two enlargings and two wider sections. A different number of enlargings and/or wider sections is also conceivable.

The device based on the lock-and-key principle preferably prevents the piston's 7 falling out of or unauthorized removal from the housing 51 in a radial direction or in a transverse or cross direction of the housing 51.

Already during insertion of the piston 7 into the housing 51, or upon displacing or shifting the piston 7 within the slot 53 of the housing 51 for the first time, and by means of fixing or attaching devices not shown in FIG. 8, such as barbed hooks, a mechanism may be actuated which prevents the piston 7 to be guided back again within the housing 51 such that the wider section 47 and the wider section 49, as shown in FIG. 8, are guided back in accordance with the enlargings 55 and 57, so that the piston 7 may detach from the housing 51 again. By means of this embodiment, an unintended falling out of the piston 7 is advantageously prevented as well as is an intended taking out of the piston 7 out of the housing 51 by the user.

For the housing of the apparatus 1, exemplarily a medical-grade styrene (or styrol)-butadiene is used.

FIG. 9 shows a further embodiment of the apparatus 1 according to the invention in a lateral or side view, wherein the apparatus 1 is tweezers-shaped and comprises two arms 58, 59 having one jaw 60, 61 each at an end hereof. The contact device 17 is clamped between the two jaws 60 and 61. At the end 62 of the apparatus 1 opposite to the jaws 60, 61, a clamping or pushable or pushing, respectively, device 63 is provided which grips or grasps or encompasses parts of the apparatus 1.

The clamping or pushable or pushing, respectively, device 63 is designed such that it may fix the arms 58, 59 of the apparatus 1 according to the invention in at least one position relative to each other. Thus, the distance between the jaws 60, 61 is ensured or kept.

Furthermore, the clamping or pushable or pushing, respectively, device 63 according to the invention may be designed in order to adjust or set the distance between the arms 58, 59 in such a variable manner that the apparatus 1 is thus adapted or adjusted or fit to the different sizes of the contact device 17.

The clamping or pushable or pushing, respectively, device 63 may be an element which is independent from the apparatus 1, or it may be permanently—but preferably displaceably or shiftably—connected with the apparatus 1. It may, e.g., be a section thereof.

The clamping or pushable or pushing, respectively, device 63 may be designed such that it may be displaced or shifted forwards and backwards in the longitudinal direction of the apparatus 1.

The upper representation of FIG. 9 shows a possible embodiment of the apparatus 1 according to the invention in an open position without any noteworthy clamping effect on or onto the contact device 17. The clamping or pushable or pushing, respectively, device 63 is placed or located at an end 62.

The lower representation of FIG. 9 shows the apparatus 1 in a closed position or a position for use, respectively. For achieving the closed position, the clamping or pushable or pushing, respectively, device 63 is moved along the apparatus 1, thereby closing the arms 58 and 59 of the apparatus 1, and is being placed in a first position over or above the jaws 60 and 61 acting as a fixing aid. Thereby, an unwanted slipping or falling out of the contact device 17 is prevented by means of clamping.

One or more jaws 60, 61 may comprise barbed hooks or other devices for increasing or enhancing an adhesion of the jaws 60, 61 at or on the contact device 17, for hooking in or into the contact device 17, or for a differently designed frictional and/or form closure connection of at least one of the jaws 60, 61 with the contact device 17.

The clamping or pushable or pushing, respectively, device 63 may also be placed in a second position (not shown) over or above the contact device 17. In the second position, the contact device 17 or a section hereof is compressed, and the blood—or fluid in general—present therein may be squeezed or pushed out thereof.

Furthermore, the clamping or pushable or pushing, respectively, device 63 may be designed for being turned around or about the longitudinal axis of the apparatus 1. Thereby, the contact device 17 may be wrung or wrung out. Suitable guiding structures (not shown) for achieving a rotary motion may be provided in a section of the clamping or pushable or pushing, respectively, device 63 and/or at or on the apparatus 1.

FIG. 10a shows a front view of the jaws 60, 61 of the apparatus 1 according to the invention of FIG. 9, gripped or grasped or encompassed by the clamping or pushable or pushing, respectively, device 63. In the represented embodiment, the jaws 60, 61 of the apparatus 1 are each semicircular in a cross-section thereof. The clamping or pushable or pushing, respectively, device 63 is ring-shaped or circular in a cross-section. The contact areas of the jaws 60, 61 for contacting the contact device 17 are hereby flat or plane, respectively, or substantially plane and/or are parallel or substantially parallel to each other.

FIG. 10b shows the jaws 60, 61 in a front view of a further embodiment, wherein the jaws 60, 61 of the apparatus 1 according to the invention are each arch-shaped or C-shaped in a cross-section thereof. Preferably, they may each form a semicircle. Together, their inner circumferences may preferably form a full circle. Thus, sections of the contact device having a round or circular cross-section may advantageously be accommodated with substantially the same pressure distributed across the circumference or periphery of the section. The clamping or pushable or pushing, respectively, device 63 may again be circular in a cross-section, as is exemplarily shown in FIG. 10b.

FIG. 11 shows in a perspective view a possible embodiment of a depository device 64 for depositing the apparatus 1 according to the invention when it is not needed. The depository device 64 comprises a socket or pedestal 65 with a slit-shaped or U-shaped opening having side walls 66, in the interiors of which the apparatus 1 according to the invention may be supported. A contact area 68 of the socket or pedestal 65 for depositing the apparatus 1 according to the invention is placed so high above a platform of the depository device 64 that the contact device 17 does not get into contact with the platform for the depository device 64. The contact device 17 thus remains free from impurities or contamination resulting from support-related resting or lying, or contact with the supporting surface or items. The depository device 64 may be made of metal or synthetic material, or any other appropriate material. It is preferably sterilizable.

FIG. 12 shows a sectional view of a further embodiment of the depository device 64 for placing or depositing the apparatus 1 according to the invention when it is not in use. The depository device 64 comprises an accommodation 69 having at least one opening 67 for inserting or introducing a section of the apparatus 1 according to the invention. The depository device 64 is designed such that it cannot overturn or topple over during normal use. For this purpose, the depository device 64 may have, e.g., a particular geometry or weight distribution. The depository device 64 may be made of metal or synthetic material, or any other appropriate material. It is preferably sterilizable.

1.-42. (canceled)

43. An apparatus for collecting blood or a different fluid escaping from a wound area, wherein the apparatus comprises a contact device for contacting blood or fluid within the wound area, the contact device comprising within an interior thereof a multitude of pores for absorbing the blood or fluid contacted by the contact device.

44. The apparatus of claim 43, wherein the apparatus further comprises a suction device for generating a suction acting on the contact device.

45. The apparatus of claim 43, wherein the apparatus further comprises a compressing device for applying pressure onto the contact device in order to release the blood or fluid absorbed within the interior thereof.

46. The apparatus of claim 43, wherein the apparatus further comprises a blood reservoir for retaining collected blood or collected fluid after the collected blood or collected fluid has left the interior of the contact device.

47. The apparatus of claim 43, wherein the apparatus further comprises a connecting device for connecting the apparatus to an injection syringe in a fluid communication.

48. The apparatus of claim 43, wherein the apparatus further comprises a pushable or pushing device for applying pressure onto the contact device for draining blood or fluid out of the contact device.

49. The apparatus of claim 43, wherein the apparatus further comprises a pushing device for applying pressure onto the contact device for at least once draining blood or fluid out of the contact device into a reservoir.

50. The apparatus of claim 43, wherein the apparatus further comprises a housing and a reservoir and the housing comprises a resealable opening for extracting blood or fluid out of a reservoir.

51. The apparatus of claim 50, wherein the apparatus further comprises a device for closing the resealable opening.

52. The apparatus of claim 43, wherein the apparatus further comprises a reservoir and a suction device for draining the blood or the fluid from the reservoir.

53. The apparatus of claim 43, wherein the apparatus further comprises a rotary device, a rotary motion of which is transmitted by a device to or onto a guiding device at or to or onto which the contact device is fixed or attached.

54. The apparatus of claim 43, wherein the apparatus further comprises a pushing device that extends to an exterior of the apparatus, for transferring the contact device from the exterior of the apparatus into an interior of the apparatus.

55. The apparatus of claim 43, wherein the apparatus further comprises a reservoir for taking in bone replacement material and/or at least one reservoir comprising bone replacement material.

56. The apparatus of claim 43, wherein the apparatus further comprises an at least partly hollow piston having a partial opening for accommodating the contact device and/or for fixing or attaching the contact device in or within the piston.

57. The apparatus of claim 56, wherein at least one of the partial opening and the at least partly hollow piston are designed to be capable of accommodating the contact device solely by a clamping effect.

58. The apparatus of claim 56, wherein the partial opening is present as or comprises a slot opening that connects an interior of the piston with an exterior of the piston.

59. The apparatus of claim 58, wherein the partial opening comprises a saw tooth structure.

60. The apparatus of claim 56, wherein the piston, in at least one interior thereof, comprises a hook or barbed hook structure for contacting the contact device.

61. The apparatus of claim 43, wherein the apparatus further comprises a housing having at least one transparent section.

62. The apparatus of claim 43, wherein the apparatus further comprises a one-piece housing and a one-piece piston.

63. The apparatus of claim 62, wherein the apparatus further comprises a fixing or attaching device for fixing or attaching the contact device at least one of at, to, and onto the piston.

64. The apparatus of claim 62, wherein the piston comprises a profile staggered in a longitudinal direction of the piston, the profile having at least two widths or cross-sectional diameters or cross-sectional areas that differ from each other in a radial direction or along a periphery of the piston.

65. The apparatus of claim 43, wherein the apparatus further comprises a housing having a slot that comprises different widths.

66. The apparatus of claim 43, wherein the apparatus further comprises a housing, a piston, and a device for at least one of supporting or bearing and guiding the piston in or within the housing.

67. The apparatus of claim 43, wherein the apparatus further comprises a housing, a piston, and at least one fixing or attaching device for securing the piston against falling out and/or being taken out of the housing after its insertion in or into the housing.

68. The apparatus of claim 43, wherein the apparatus has a shape of tweezers or comprises a section having a shape of tweezers and at least two arms having at least one jaw each for gripping the contact device, as well as at least one clamping or pushable or pushing, respectively, device by which an action or effect may be exerted on sections of the apparatus for fixing the arms in a position relative to each other.

69. The apparatus of claim 68, wherein the pushable or pushing device is permanently connected to the apparatus.

70. The apparatus of claim 68, wherein the pushable or pushing device is an element that is independent from the apparatus.

71. The apparatus of claim 68, wherein at least one of the jaws of the tweezer-like device comprises a semicircular section for contacting the contact device.

72. The apparatus of claim 68, wherein at least one of the jaws of the tweezer-like device comprises an arch-shaped or C-shaped section for contacting the contact device.

73. A clamping or pushable or pushing, respectively, device for use in combination with the apparatus of claim 43, wherein the device is designed to be shiftable or pushable along the apparatus.

74. A depository device for depositing the apparatus of claim 43, wherein the depository device comprises a socket or pedestal that comprises at least one opening which is designed for supporting the apparatus within an interior of the opening, or a protrusion for putting or slipping the apparatus on or onto the protrusion for depositing the apparatus.

75. The depository device of claim 74, wherein the opening is slit-shaped.

76. The depository device of claim 74, wherein the opening is U-shaped.

77. The depository device of claim 74, wherein a contact area of the socket or pedestal is designed such that the apparatus deposited within the opening and/or its contact device is kept from contacting a platform of the depository device.

78. A depository device for putting down or placing the apparatus of claim 43, wherein the device comprises an accommodation that comprises at least one opening for putting down or placing, respectively, or putting in or placing in or into, respectively, the apparatus.

79. The depository device of claim 74, wherein the depository device is constructed geometrically such that it cannot or will not overturn or topple over during normal use.

80. The depository device of claim 74, wherein the depository device has a weight distribution such that overturning or toppling over during normal use is counteracted.

81. The depository device of claim 74, wherein the device is sterilizable.

82. A kit, wherein the kit comprises the apparatus of claim 43 and at least one clamping or pushable or pushing, respectively, device that is designed to be shiftable or pushable along the apparatus.

83. A kit, wherein the kit comprises the apparatus of claim 43 and (i) a depository device for depositing the apparatus that comprises a socket or pedestal, which comprises at least one opening that is designed for supporting the apparatus within an interior of the opening, or a protrusion for putting or slipping the apparatus on or onto the protrusion for depositing the apparatus, or (ii) a depository device for putting down or placing the apparatus of claim 43, wherein the device comprises an accommodation that comprises at least one opening for putting down or placing, respectively, or putting in or placing in or into, respectively, the apparatus.

84. The kit of claim 83, wherein the kit further comprises at least one clamping or pushable or pushing, respectively, device that is designed to be shiftable or pushable along the apparatus.
